(19) United States
(12) Patent Application Publication
(10) Pub. No.: US 2026/0160187 A1
(43) Pub. Date: Jun. 11, 2026

(54) POWER CONVERTER TOPOLOGY AND CONTROL SCHEME FOR MITIGATING THERMAL BOWING IN GAS TURBINE ENGINES

(71) Applicant: GENERAL ELECTRIC COMPANY, Evendale, OH (US)

(72) Inventors: Phuc Huynh, Schenectady, NY (US); John Thomas Garrity, Niskayuna, NY (US); Brian Devendorf, Lynn, MA (US)

(21) Appl. No.: 18/966,518

(22) Filed: Dec. 3, 2024

(51) Int. Cl. F01D 25/36; F01D 21/00

(52) U.S. Cl. CPC F01D 25/36; F01D 21/00; F05D 2260/903; F05D 2270/11

(57) ABSTRACT

A gas turbine engine includes a compressor section including a compressor rotor shaft assembly and a permanent magnet alternator (PMA) including a rotor shaft drivingly coupled to the compressor rotor shaft assembly. An accessory unit including a power source and power converter circuit is electrically coupled to the PMA. The power converter circuit is configured to control delivery of current from the power source to the PMA to generate a torque on the rotor shaft that causes rotation of the compressor rotor shaft assembly to mitigate thermal bowing during an engine shutdown phase.

### TECHNICAL FIELD

The present disclosure relates generally to mitigating thermal bowing in gas turbine engines.

### BACKGROUND

Gas turbine engines, such as those providing propulsion for aircraft, generate heat at the rotor assemblies during operation. Following shutdown of the engine, the rotor assembly is stationary (i.e., not rotating), which generally results in asymmetric heat distribution or thermal gradients circumferentially and/or axially along the rotor assembly. Such thermal gradients may generally result in thermal bowing or a bowed rotor, such as along the radial, axial, and/or circumferential directions. The bowed rotor results in relatively large eccentricity relative to one or more casings surrounding the rotor assembly. As such, when a rotor assembly resumes operation, such eccentricity may generally cause the rotor assembly to operate with undesirable magnitudes of vibrations such as to damage surrounding casings, bearing assemblies, load structures, etc. Furthermore, such operation of the engine may result in airfoil blade tips rubbing into the surrounding casing, resulting in damage to the blades, the casings, or both.

Known methods to mitigate bowed rotor include allowing the rotor assembly to rest until the thermal gradient has naturally decreased over time such as to remove or eliminate the bowed rotor condition. However, in various instances, an engine may need to restart sooner than free convection heat transfer may allow. As such, there is a need for systems for reducing the thermal gradient of the rotor assembly such as to mitigate rotor bow in gas turbine engines.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic cross sectional view of a gas turbine engine incorporating systems and methods for mitigating thermal bowing according to an aspect of the present disclosure;

FIG. 2 is an exemplary chart depicting torque produced by a permanent magnet alternator as a function of rotational rotor position according to aspects of the present disclosure;

FIG. 3 is an exemplary chart depicting the permanent magnet alternator rotor torque as a function of rotational rotor position to illustrate a rotor-advancing control scheme according to aspects of the present disclosure;

FIG. 4 is an exemplary chart depicting a current-control scheme for mitigating thermal bowing according to aspects of the present disclosure;

FIG. 5 is a schematic diagram of a power converter circuit according to aspects of the present disclosure; and

FIG. 6 is an exemplary flowchart outlining a method for mitigating thermal bowing in a gas turbine engine.

Repeat use of reference characters in the specification and drawings is intended to represent the same or analogous features or elements of the present disclosure.

### DETAILED DESCRIPTION

Although this disclosure will be described in terms of specific aspects, it will be readily apparent to those skilled in this art that various modifications, rearrangements, and substitutions may be made without departing from the spirit of this disclosure.

For the purpose of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the features illustrated herein, and any additional applications of the principles of this disclosure, as illustrated herein, which would occur to one skilled in the relevant art and having possession of this disclosure, are to be considered within the scope of this disclosure.

Approximating language, as used herein, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Conventionally, when a turbine engine is shut down, due to high temperatures within the core engine, heat stratifies in the engine core. In a compressor, and, more particularly, within a high pressure compressor, an upper portion of the compressor rotors at the upper side of the compressor tend to become hotter than the lower portion the compressor rotors at the lower side of the compressor due to rising heat within the compressor section. The stratification can often lead to a high temperature difference between the upper portion of the compressor rotors and the lower portion of the compressor rotors, which leads to asymmetrical thermal expansion between the upper portion of the compressor rotors and the lower portion of the compressor rotors. In this case, the upper portion of the compressor rotors thermally expand a greater axial and/or radial amount than the lower portion of the compressor rotors, causing what is referred to as a bowed-rotor condition. The bowed-rotor condition may occur within ten minutes of the engine being turned off and may last up to eight hours. This can lead to a bowed-rotor condition in which the bowed shaped rotor, when rotated, may contact a stator of the compressor and leads to rubbing against the stator. Furthermore, the unbalance induced by the bowed rotor shape will lead to dynamics deflections from the rotor rotation during the next engine startup. Repeated contact or rubbing with the stator during rotation of the compressor rotor during the next engine startup with a bowed-rotor condition may cause damage to the engine.

The present disclosure addresses the foregoing by using the engine's existing permanent magnet alternator (PMA) to rotate the engine's compressor rotor shaft assembly, which in turn rotates the engine's compressor rotors, during an engine shutdown phase. According to an aspect of the present disclosure, the PMA may include a rotor shaft drivingly coupled to a gearbox, which in turn is drivingly coupled with the engine's compressor rotor shaft assembly. A power converter circuit controls the PMA using one or more control schemes to achieve a desired average rotational speed for the PMA's rotor shaft, which in turn serves to rotate the engine's compressor rotors during cool down to mitigate the thermal bowing phenomenon. The power converter circuit includes a dual H-bridge configuration that independently applies a specific amount of current, in a specific pattern, and for a specific duration into separate windings of the PMA. More specifically, the one or more control schemes involve applying current pulses to the separate windings of the PMA according to a predetermined profile to setup an initial position of the PMA's rotor shaft and to continuously advance the position of the PMA's rotor shaft in a defined rotational direction. Rest periods between pulses controls the amplitude of the current delivered to the separate windings of the PMA to achieve a specific average rotational speed of the PMA's rotor shaft. Rotation of the PMA's rotor shaft correspondingly rotates the engine's compressor rotors to mitigate the thermal bowing phenomenon.

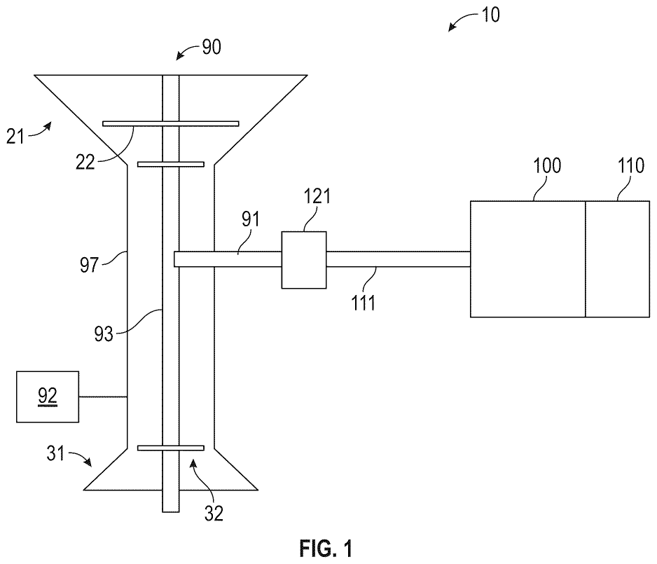

Referring now to the figures, FIG. 1 is a schematic view of exemplary embodiments of a gas turbine engine 10 according to an aspect of the present disclosure. The engine 10 includes a compressor section 21 and a turbine section 31 in serial flow arrangement. The engine 10 further includes a combustion section disposed between the compressor section 21 and the turbine section 31, in which the combustion section produces combustion products that expand at the turbine section 31 to generate thrust.

The engine 10 includes a rotor assembly 90 including a driveshaft 93 extended along a longitudinal direction, The rotor assembly 90 includes a rotor extended along a radial direction from the driveshaft 93, such as a compressor rotor 22 and a turbine rotor 32 each coupled to the driveshaft 93 as depicted schematically in FIG. 1. The compressor rotor 22 may include a disk or drum extended radially from the driveshaft 93. The compressor rotor 22 further includes a plurality of airfoils, such as installed or affixed to the disk or drum, or manufactured integrally to the disk (e.g., a bladed disk or integrally bladed rotor).

In aspects of the present disclosure, the compressor section 21 includes one or more compressors in serial flow arrangement to one another. For example, the compressor section 21 may define a high pressure (HP) compressor. In some aspects, the compressor section 21 may further define an intermediate and/or low pressure compressor. Each compressor is defined generally mechanically independent of one another, such that rotation of one does not necessarily induce rotation of another, except insofar as the compressors are in aerodynamic dependency due to the serial flow of fluid therethrough. However, it should be appreciated that in some aspects, one or more compressors may be in mechanical dependency, such as via a speed change device (e.g., gear assembly). Still further, it should be appreciated that the compressor section 21 may further include a propeller or fan assembly. For example, the engine 10 may define a turbofan, turboprop, turbojet, etc. configuration.

In aspects of the present disclosure, the turbine section 31 includes one or more turbines in serial flow arrangement to one another. For example, the turbine section 31 may define a HP turbine. In another aspect, the turbine section 31 may further define an intermediate and/or low pressure turbine. Each turbine is coupled to each compressor, such as described above, via one or more driveshafts 93, such as to define each rotor assembly 90 as generally mechanically independent of one another, except insofar as the turbines are in aerodynamic dependency due to serial flow of fluid therethrough. Similarly, it should be appreciated that in other embodiments one or more turbines and rotor assemblies may be in mechanical dependency, such as via a speed change device.

Referring still to FIG. 1, the engine 10 further includes a casing 97 surrounding the rotor assembly 90. Various embodiments of the casing 97 further include shrouds and seals, such as abradable materials or other structures radially adjacent to the rotor assembly 90 such as to define a relatively closely formed primary flow path across which air and combustion gases flow to generate thrust. In some aspects, the casing 97 may further define a fan casing surrounding the rotor assembly 90 defining fan blades of a fan assembly. In some aspects, the casing 97 may further define a core engine casing surrounding the rotor assembly 90 defining one or more of a compressor rotor, a turbine rotor, or both.

Operation of the engine 10 may be controlled in whole or in part by an electronic engine controller, shown schematically at 92. One example of such an engine controller 92 is a full authority digital engine control (“FADEC”). The engine controller 92 may be mounted in any convenient location or in the engine 10, including, but not limited to, within a fan nacelle, or within the core engine.

The engine 10 further includes a permanent magnet alternator (PMA) 100 coupled to the rotor assembly 90 and an accessory unit 110 that is configured to be electrically and/or mechanically coupled to the PMA 100. In aspects of the present disclosure, the PMA 100 may be configured to generate and supply electric power to the FADEC and/or various components of the engine 10 (e.g., an ignition coil). The PMA 100 includes a rotor shaft 111 that is drivingly coupled to a transfer gearbox 121. The transfer gearbox 121 is drivingly coupled to a rotatable shaft 91, which in turn is drivingly coupled to the driveshaft 93 of the rotor assembly 90. During an engine shutdown phase, the rotor shaft 111 is rotated by the PMA 100, thereby rotating the rotatable shaft 91 via the transfer gearbox 121, which in turn rotates the driveshaft 93 of the rotor assembly 90. In aspects of the present disclosure, the transfer gearbox 121 may be coupled to the casing 97.

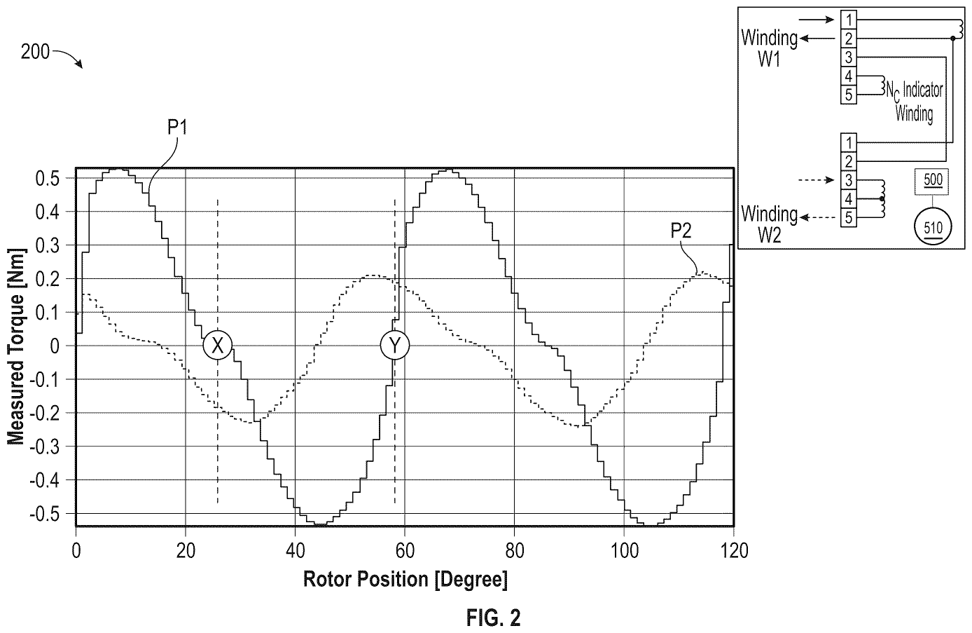

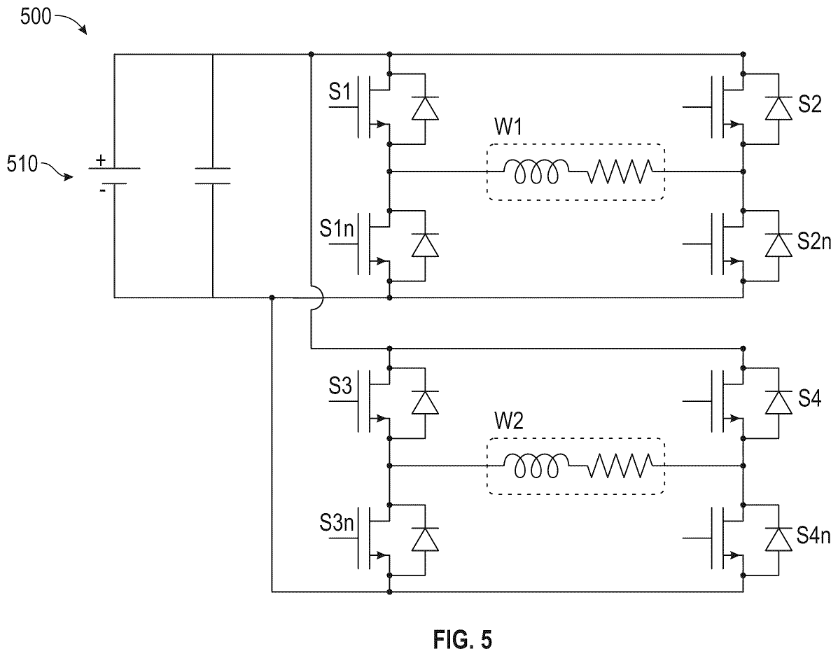

As detailed below, the accessory unit 110 is configured to be coupled to the PMA 100 and includes a power converter circuit 500 and a power source 510 (FIGS. 2 and 5). The power source 510 may be, for example, a DC power source such as a battery, aircraft on-board DC power supply, or airport DC power supply. In aspects of the present disclosure, the power source 510 may be configured to provide, for example, DC voltage up to 200 volts. The power converter circuit 500 serves to independently regulate current delivered from the power source 510 to corresponding independent windings W1, W2 of the PMA 100. By independently controlling current delivered to the windings W1, W2 of the PMA 100, the operable coupling of the rotor shaft 111 to the rotor assembly 90 can be leveraged to rotate the driveshaft 93 of the rotor assembly 90 at a desired average rotational speed during the engine's post shutdown cool-down phase to expose the rotor assembly 90 to heat in the core engine evenly, thereby mitigating the thermal bowing phenomenon and allowing the engine 10 to be restarted without damaging the engine 10. In aspects of the present disclosure, the accessory unit 110 may be, for example, a line replacement unit (LRU).

Referring now to FIG. 2, a chart 200 depicting the torque (measured in Newton-meters) generated by the PMA 100 as a function of the rotational position of the rotor shaft 111 (measured in degrees) under constant DC current excitation is shown and illustrates the torque characteristics of the PMA 100. The windings W1, W2 of the PMA 100 serve to convert current provided by the power source 510 (FIGS. 2 and 5) into torque. The torque is determined by the interaction between the current and the position of the rotor shaft 111. If a certain amount of torque is desired, the electric current delivered to the windings W1, W2 of the PMA 100 and the position of the rotor shaft 111 is known. If the position of the rotor shaft 111 is known, the amount and direction (e.g., positive or negative) of current delivered to the windings W1, W2 can be controlled to achieve a desired amount of torque generated by the PMA 100 and the initial position of the rotor shaft 111 can be set. For example, a first plot P1 is generated by turning off winding W2 and applying current from the power source 510 to winding W1 in a positive direction (e.g., going into terminal 1 and out of terminal 2). Applying current into winding W1 and using an external turning device to rotate the rotor shaft 111 in a positive rotational direction (e.g., counter-clockwise or clockwise), the resulting torque produced on the rotor shaft 111 is measured to generate plot P1. As shown in plot P1, if the position of the rotor is at about 10 degrees, then the torque produced on the rotor shaft 111 is at a maximum (e.g., more than about 0.50 Nm). If the position of the rotor shaft 111 is advanced, then torque produced on the rotor shaft 111 declines. For example, if the position of the rotor shaft 111 is advanced past 25 degrees, the torque produced on the rotor shaft 111 is reversed and the torque produced on the rotor shaft 111 is negative. When the position of the rotor shaft 111 reaches about 50 degrees, the maximum negative torque on winding W1 is achieved. A similar experiment was performed to generate a second plot P2 by turning off winding W1 and applying current from the power source 510 into winding W2 in the positive direction (e.g., going into terminal 3 and out of terminal 5). In aspects of the present disclosure, the peak output current applied to windings W1, W2 may be 20 amps.

There are two equilibrium points X, Y on plot P1, both of which depend on the direction of the current. Equilibrium point X corresponds to the positive direction of the current and equilibrium point Y corresponds to the negative direction of the current. Starting at any position of the rotor shaft 111, application of current to winding W1 in the positive direction produces a positive torque and causes the rotor shaft 111 to rotate in the positive rotational direction (e.g., counter-clockwise). At equilibrium point X, no torque is produced and the rotor shaft 111 will stop rotating and settle to a position of about 25 degrees. If the position of the rotor shaft 111 is greater than about 25 degrees and less than the maximum negative torque (e.g., rotor position at about 50 degrees) such that the torque produced on the rotor shaft 111 is negative, then applying current to winding W1 in the positive direction while the torque is negative will cause the rotor shaft 111 to rotate in the negative rotational direction until the rotor shaft 111 position is returned to equilibrium point X and the rotor shaft 111 does not rotate. It is in this manner that the initial position of the rotor shaft 111 can be set. No matter what the position of the rotor shaft 111 is, when current is applied in the positive direction, the position of the rotor shaft 111 will settle to equilibrium point X. If current is applied in the negative direction, the position of the rotor shaft 111 will settle to equilibrium point Y.

There is no position of the rotor shaft 111 where torque cannot be produced. At equilibrium point X, where winding W1 does not produce torque on the rotor shaft 111, winding W2 can be used to produce torque on the rotor shaft 111. At the zero crossing of plot P2, where winding W2 does not produce torque on the rotor shaft 111, winding W1 can be used to produce torque on the rotor shaft 111. In this manner, either of the two windings W1, W2 separately or a combination of the two windings W1, W2 may be used to produce torque on the rotor shaft 111 regardless of the position of the rotor shaft 111.

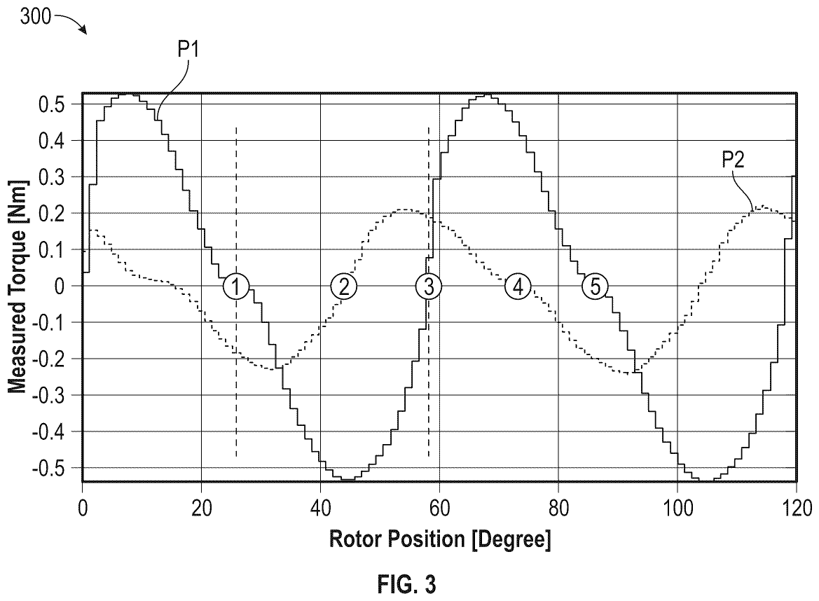

Turning now to FIG. 3, a chart 300 depicting a rotor-advancing control scheme for incrementally advancing the rotor shaft 111 is shown. As in FIG. 2, plot P1 corresponds to winding W1 and plot P2 corresponds to winding W2. To set the initial position of the rotor shaft 111 at position 1 (e.g., about 25 degrees), current is applied to winding W1 in the positive direction. Depending on the settled position of the rotor shaft 111 after engine shut down, the rotor shaft 111 will rotate either in the positive rotational direction (e.g., counter clockwise) or in the negative rotational direction (e.g., clockwise) until it reaches position 1. If the rotor shaft 111 is already at position 1, the rotor shaft 111 will not rotate in response to current applied to winding W1.

Since, at position 1, winding W1 does not produce torque on the rotor shaft 111, current is instead applied to winding W2 in the negative direction to produce positive torque on the rotor shaft 111 that rotates the rotor shaft 111 in the positive rotational direction to position 2. At position 1, if current were to be applied to winding W2 in the positive direction, the torque applied to the rotor shaft 111 would be negative and the rotor shaft 111 would be rotated in the negative rotational direction away from position 2. Since, at position 2, winding W2 does not produce torque on the rotor shaft 111, a negative current is applied to winding W1 to produce positive torque on the rotor shaft 111 that rotates the rotor shaft 111 in the positive rotational direction to position 3. At position 3, winding W1 does not produce torque on the rotor shaft 111. However, at position 3, since the torque characteristic is flipped (e.g., the torque characteristic changes its sign), a current is applied to winding W2 in the positive direction to produce positive torque on the rotor shaft 111 that rotates the rotor shaft 111 in the positive rotational direction to position 4. In the context of the present disclosure, “torque characteristic” may be defined as the torque produced by the PMA 100 on the rotor shaft 111 given a specific position of the rotor shaft 111 and a specific DC current flowing to the winding (e.g., winding W2) in the positive direction. Given a positive current, when the torque characteristic is flipped the torque characteristic changes its sign because of a different rotor position. For example, at position 3, a positive torque is needed to rotate the rotor shaft 111 to position 4. Since the torque characteristic of plot P2 is positive at position 3, the rotor shaft 111 is rotated to position 4 by applying current in a positive direction to winding W2 to produce a positive torque. In contrast, for example, a positive torque is needed at position 1 to rotate the rotor shaft 111 to position 2. Since the torque characteristic of plot P2 is negative at position 1, the rotor shaft 111 is rotated to position 2 by applying current in a negative direction to winding W2 to produce a positive torque.

At position 4, current is applied to winding W1 in the positive direction to produce positive torque on the rotor shaft 111 and rotate the rotor shaft 111 in the positive rotational direction to position 5. Position 5 is identical to position 1 in terms of torque characteristic. Thus, the entire sequence (e.g., rotation of the rotor shaft 111 in the positive rotational direction from position 1 to position 5) can be repeated to maintain rotation of the rotor shaft 111 in the positive rotational direction for the entirety of the sequence. Rotation of the rotor shaft 111 in the positive rotational direction results in corresponding rotation of the rotor assembly 90 in the positive rotational direction.

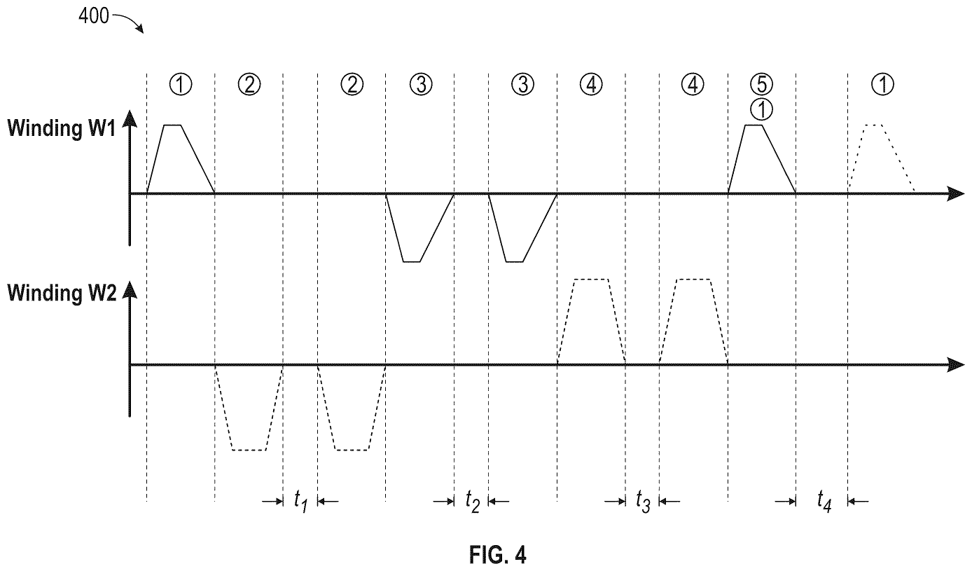

In order to realize the rotor-advancing control scheme of FIG. 3, the amount of current being applied to each of the windings W1, W2 is controlled according to the current-control scheme 400 depicted in FIG. 4. The applied current will either be in the positive direction or the negative direction and the amplitude of the current is controlled to ensure a sufficient amount of torque is applied to the rotor shaft 111. As illustrated in FIG. 4, the current applied to windings W1, W2 is pulsed at each of the rotor positions (e.g., positions 1-5) in a manner that is sufficient to advance the rotor shaft 111 to the next position (e.g., from position 1 to position 2). At each rotor position, a rest period (e.g., t₁, t₂, t₃, t₄) between current pulses applied to either winding W1 or winding W2 is employed such that there is a period of rest (e.g., tens of seconds) before current is reapplied to advance the rotor shaft 111 to the next position. In aspects of the present disclosure, each of the rest periods (e.g., t₁, t₂, t₃, t₄) may be a parameter that can be controlled and/or adjusted (e.g., via the power converter circuit 500) to achieve a specific rotational speed of the rotor shaft 111. By controlling the rest period (t₁, t₂, etc.), the average rotational speed of the rotor shaft 111, and thus the average rotational speed of the rotor assembly 90, can be controlled. For example, once the position of the rotor shaft 111 is set at position 1, a current pulse is applied to winding W2 in the negative direction to rotate the rotor shaft 111 in the positive rotational direction to position 2. After rest period t₁, a current pulse is applied to winding W2 in the negative direction to re-establish the position of the rotor shaft 111, nullifying any unexpected rotor movement during the rest period t₁. At position 2, a current pulse is applied to winding W1 in the negative direction to rotate the rotor shaft 111 in the positive rotational direction to position 3. After rest period t₂, a current pulse is re-applied to winding W1 in the negative direction to nullify unexpected movement of the rotor shaft 111 during the rest period t₂. At position 3, a current pulse is applied to winding W2 in the positive direction to rotate the rotor shaft 111 in the positive rotational direction to position 4. After rest period t₃, a current pulse is re-applied to winding W2 in the positive direction to nullify unexpected movement of the rotor shaft 111 during the rest period t₃. At position 4, a current pulse is applied to winding W1 in the positive direction to rotate the rotor shaft 111 to position 5. A rest period t₄ follows. Since position 5 is identical to position 1 in terms of torque characteristic, the entire sequence (e.g., rotation of the rotor shaft 111 in the positive rotational direction from position 1 to position 5) is repeated to maintain rotation of the rotor shaft 111 in the positive rotational direction. This cycle repeats for a period of time to continuously rotate the rotor shaft 111, and thus the rotor assembly 90, in the positive rotational direction to mitigate thermal bowing post engine shutdown.

With reference to FIG. 5, the power converter circuit 500 is shown connected to the power source 510 and includes a dual H-bridge topology for connecting to windings W1 and W2, where one H-bridge connects to winding W1 and another H-bridge connects to winding W2. This configuration serves to enable bidirectional application of current from the power source 510 to windings W1, W2, as well as control of the amplitude of the current applied from the power source 510 to the windings W1, W2.

For purposes of describing FIG. 5, current flowing from left to right is defined as the positive direction and current flowing from right to left is defined as the negative direction. For purposes of providing additional context of “left” and “right” in FIG. 5, switches S2 and S2n are considered to be positioned to the right of winding W1 and switches S1 and S1n are considered to be positioned to the left of winding W1. Likewise, switches S4 and S4n are considered to be positioned to the right of winding W2 and switches S3 and S3n are considered to be positioned to the left of winding W2. To apply current to winding W1 in the positive direction, switches S1 and S2n are turned on such that the left side of winding W1 is connected to the positive side of the power source 510 and the right side of winding W1 is connected to the negative side of the power source 510. In this configuration of the power converter circuit 500, current flows in the positive direction (from left to right) through winding W1. To apply current to winding W1 in the negative direction, switches S1n and S2 are turned on such that the right side of winding W1 is connected to the positive side of the power source 510 and the left side of winding W1 is connected to the negative side of the power source 510. In this configuration of the power converter circuit 500, current flows in the negative direction (from right to left) through winding W1.

To apply current to winding W2 in the positive direction, switches S3 and S4n are turned on such that the left side of winding W2 is connected to the positive side of the power source 510 and the right side of winding W2 is connected to the negative side of the power source 510. In this configuration of the power converter circuit 500, current flows in the positive direction (from left to right) through winding W2. To apply current to winding W2 in the negative direction, switches S3n and S4 are turned on such that the right side of winding W2 is connected to the positive side of the power source 510 and the left side of winding W2 is connected to the negative side of the power source 510. In this configuration of the power converter circuit 500, current flows in the negative direction (from right to left) through winding W2. When switches S1, S1n, S2, S2n, S3, S3n, S4, and S4n are off, there is no current being applied to either of windings W1, W2.

By pulsing the current applied to windings W1, W2, as described above with respect to FIG. 4, the duration of time that windings W1, W2 are connected to the power source 510 can be controlled, thereby allowing for control of the amount of current on average flowing through the windings W1, W2. More specifically, by pulsing the current applied to windings W1, W2, the amplitude of the applied current can be controlled. In aspects of the present disclosure, for example, the amplitude of the current applied to windings W1, W2 may be controlled by applying a duty cycle of 50% to the pulsed current generated by the power source 510. It will be understood that other duty cycles are contemplated (e.g., 25%, 75%, etc.) by the present disclosure for controlling the amplitude of the current generated by the power source 510.

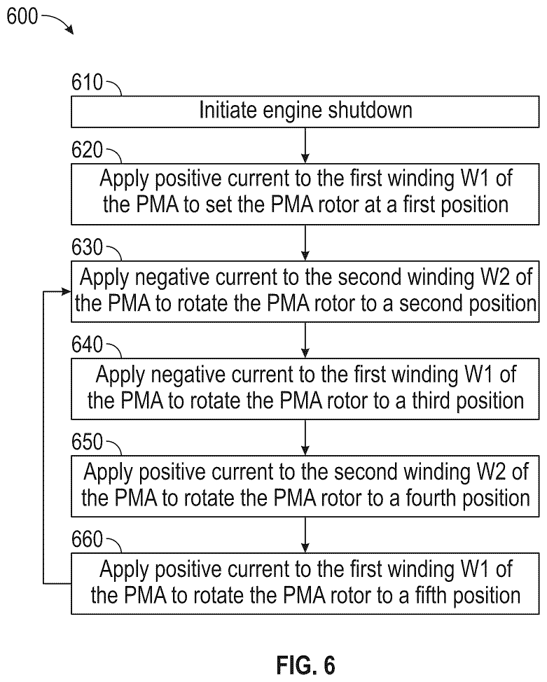

Referring now to FIG. 6, an exemplary flowchart outlining blocks of a method for mitigating thermal bowing in a gas turbine engine (hereinafter, “method 600”) is generally provided. Embodiments of the method 600 may generally be utilized or implemented with embodiments of the engine 10 generally provided in FIG. 1. However, it should be appreciated that the method 600 may be utilized or implemented with other embodiments of a gas turbine engine, such as, but not limited to, turbofan, turboprop, and turboshaft gas turbine engines, including single spool, two spool, three spool, or more, gas turbine engines. Furthermore, the method 600 includes steps presented in a sequence. However, it should be appreciated that steps of the method 600 may be re-arranged, re-ordered, re-sequenced, altered, omitted, or added to without removing from the scope of the present disclosure.

Following normal engine operations, engine shutdown is initiated at block 610, for example, by the engine controller 92 sending control commands to the engine 10. At block 620, current is applied from the power source 510 to winding W1 of the PMA 100 in the positive direction to set the position of the rotor shaft 111 at position 1. At block 630, current is applied from the power source 510 to winding W2 of the PMA 100 in the negative direction to rotate the rotor shaft 111 in a positive rotational direction (e.g., counter clockwise) to position 2. At block 640, current is applied from the power source 510 to winding W1 of the PMA 100 in the negative direction to rotate the rotor shaft 111 in the positive rotational direction to position 3. At block 650, current is applied from the power source 510 to winding W2 of the PMA 100 in the positive direction to rotate the rotor shaft 111 in the positive rotational direction to position 4. At block 660, current is applied from the power source 510 to winding W1 to rotate the rotor shaft 111 in the positive rotational direction to position 5. Since position 5 is identical to position 1 in terms of torque characteristic, the method 600 returns to block 630 to maintain rotation of the rotor shaft 111 in the positive rotational direction from position 5 (or position 1) to position 2. This cycle may be repeated for a pre-determined period of time to continuously rotate the rotor shaft 111, and thus the rotor assembly 90, in the positive rotational direction to mitigate thermal bowing post engine shutdown. In aspects of the present disclosure, the pre-determined period of time may be a parameter that can be controlled and/or adjusted (e.g., via the power converter circuit 500) to achieve a specific rotational speed of the rotor shaft 111.

With the foregoing aspects, the present disclosure provides a thermal bowing or bowed-rotor mitigation system and a related method so as to rotate the compressor rotor assembly by rotating a rotor of the engine's PMA in accordance with a rotor-advancing control scheme (FIG. 3) as controlled by a current-control scheme (FIG. 4). By providing rotation of the compressor rotor shaft assembly after engine shutdown, a bowed-rotor condition can be mitigated.

While the foregoing description relates generally to a gas turbine engine, the gas turbine engine may be implemented in various environments. For example, the engine may be implemented in an aircraft, but may also be implemented in non-aircraft applications, such as power generating stations, marine applications, or oil and gas production applications. Thus, the present disclosure is not limited to use in aircraft.

Further aspects of the present disclosure are provided by the subject matter of the following clauses.

A gas turbine engine including a compressor section including a compressor rotor shaft assembly, a permanent magnet alternator (PMA) including a rotor shaft drivingly coupled to the compressor rotor shaft assembly, wherein rotation of the rotor shaft causes corresponding rotation of the compressor rotor shaft assembly, and an accessory unit including a power source and power converter circuit electrically coupled to the PMA. The power converter circuit includes a first plurality of switches connected to a first winding of the PMA and configured to control delivery of current from the power source to the first winding for generating a torque on the rotor shaft. The power converter circuit includes a second plurality of switches connected to a second winding of the PMA and configured to control delivery of current from the power source to the second winding for generating torque on the rotor shaft. Torque on the rotor shaft causes rotation of the compressor rotor shaft assembly to mitigate thermal bowing during an engine shutdown phase.

The gas turbine engine according to the preceding clause, further including a gearbox drivingly coupled with the compressor rotor shaft assembly and the rotor shaft of the PMA.

The gas turbine engine according to any preceding clause, wherein the first plurality of switches is configured to control a direction of the current delivered to the first winding and the second plurality of switches is configured to control a direction of the current delivered to the second winding.

The gas turbine engine according to any preceding clause, further comprising a first H-bridge including the first plurality of switches, and a second H-bridge including the second plurality switches.

The gas turbine engine according to any preceding clause, wherein the power converter circuit is configured to deliver current in at least one of a positive direction or a negative direction to the first and second windings independently to generate the torque on the rotor shaft.

The gas turbine engine according to any preceding clause, wherein the power converter circuit is configured to deliver current to the first winding in a positive direction to rotate the rotor shaft in one of a positive rotational direction or a negative rotational direction to set an initial first rotational position of the rotor shaft.

The gas turbine engine according to any preceding clause, where the positive rotational direction is counter-clockwise and the negative rotational direction is clockwise.

The gas turbine engine according to any preceding clause, wherein the power converter circuit is configured to deliver current to the second winding in a negative direction to rotate the rotor shaft in the positive rotational direction from the initial first rotational position to a second rotational position, deliver current to the first winding in a negative direction to rotate the rotor shaft in the positive rotational direction from the second rotational position to a third rotational position, deliver current to the second winding in a positive direction to rotate the rotor shaft in the positive rotational direction from the third rotational position to a fourth rotational position, and deliver current to the first winding in a positive direction to rotate the rotor shaft in the positive rotational direction from the fourth rotational position to a fifth rotational position.

The gas turbine engine according to any preceding clause, wherein the power converter circuit is configured to deliver current to the first winding in a positive direction to rotate the rotor shaft in the positive rotational direction from the fifth rotational position to at least one additional rotational position.

The gas turbine engine according to any preceding clause, wherein at each of the rotational positions of the rotor shaft, the power converter circuit is configured to deliver a first pulse of current to one of the first or second windings, rest for a pre-determined time period following the delivery of the first pulse of current, and deliver a second pulse of current to one of the first or second windings following the pre-determined time period to rotate the rotor shaft to a next rotational position.

The gas turbine engine according to any preceding clause, wherein the pre-determined time period is a parameter configured to be controlled for rotating the rotor shaft at a pre-determined rotational speed.

A power converter circuit for controlling delivery of current to a permanent magnet alternator (PMA) of a gas turbine engine to mitigate thermal bowing during an engine shutdown phase. The power converter circuit includes a power source, a first H-bridge connected to a first winding of the PMA and configured to control delivery of current from the power source to the first winding, the first H-bridge including a first plurality of switches configured to control a direction of the current delivered to the first winding, wherein delivery of current to the first winding in one of a positive direction or a negative direction is configured to generate torque on a rotor shaft of the PMA, and a second H-bridge connected to a second winding of the PMA and configured to control delivery of current from the power source to the second winding, the second H-bridge including a second plurality of switches configured to control a direction of the current delivered to the second winding, wherein delivery of current from the power source to the second winding in one of the positive direction or the negative direction is configured to generate torque on the rotor shaft of the PMA.

The power converter circuit according to the preceding clause, wherein the power source is configured to deliver current to the first winding in the positive direction to rotate the rotor shaft in one of a positive rotational direction or a negative rotational direction to set an initial first rotational position of the rotor shaft.

The power converter circuit according to any preceding clause, wherein the power source is configured to deliver current to the second winding in the negative direction to rotate the rotor shaft in the positive rotational direction from the initial first rotational position to a second rotational position, deliver current to the first winding in the negative direction to rotate the rotor shaft in the positive rotational direction from the second rotational position to a third rotational position, deliver current to the second winding in the positive direction to rotate the rotor shaft in the positive rotational direction from the third rotational position to a fourth rotational position, and deliver current to the first winding in the positive direction to rotate the rotor shaft in the positive rotational direction from the fourth rotational position to a fifth rotational position.

The power converter circuit according to any preceding clause, wherein at each of the rotational positions of the rotor shaft, the power converter circuit is configured to deliver a first pulse of current to one of the first or second windings, rest for a pre-determined time period following delivery of the first pulse of current, and deliver a second pulse of current to one of the first or second windings following a predetermined time period to rotate the rotor shaft to a next rotational position.

The power converter circuit according to any preceding clause, wherein the pre-determined time period is a parameter configured to be controlled for rotating the rotor shaft at a pre-determined rotational speed.

A method of using a permanent magnet alternator (PMA) to mitigate thermal bowing in a gas turbine engine includes (a) initiating shutdown of a gas turbine engine, (b) delivering current to a first winding of a PMA in a positive direction to rotate a rotor shaft of the PMA in one of a positive rotational direction or a negative rotational direction to set an initial first rotational position of the rotor shaft, (c) delivering current to a second winding in the negative direction to rotate the rotor shaft in the positive rotational direction from the initial first rotational position to a second rotational position, (d) delivering current to the first winding in the negative direction to rotate the rotor shaft in the positive rotational direction from the second rotational position to a third rotational position, (e) delivering current to the second winding in the positive direction to rotate the rotor shaft in the positive rotational direction from the third rotational position to a fourth rotational position, and (f) delivering current to the first winding in the positive direction to rotate the rotor shaft in the positive rotational direction from the fourth rotational position to a fifth rotational position.

The method according to any preceding clause, wherein delivery of current to the first and second windings is configured to generate a torque on the rotor shaft to cause rotation of the rotor shaft.

The method according to any preceding clause, further including at each of the rotational positions of the rotor shaft delivering a first pulse of current to one of the first or second windings, resting for a pre-determined time period following the delivery of the first pulse of current, and delivering a second pulse of current to one of the first or second windings following the pre-determined time period to rotate the rotor shaft to a next rotational position.

The method according to any preceding clause, further including controlling a direction of the current delivered to the first winding using a first H-bridge and controlling a direction of the current delivered to the second winding using a second H-bridge.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an aspect,” “in aspects,” “in various aspects,” “in some aspects,” or “in other aspects” may each refer to one or more of the same or different aspects in accordance with this disclosure.

What is claimed is:

1. A gas turbine engine, comprising:
a compressor section including a compressor rotor shaft assembly;
a permanent magnet alternator (PMA) including a rotor shaft drivingly coupled to the compressor rotor shaft assembly, wherein rotation of the rotor shaft causes corresponding rotation of the compressor rotor shaft assembly; and
an accessory unit including a power source and power converter circuit electrically coupled to the PMA, wherein the power converter circuit includes:
a first plurality of switches connected to a first winding of the PMA and configured to control delivery of current from the power source to the first winding for generating a torque on the rotor shaft; and
a second plurality of switches connected to a second winding of the PMA and configured to control delivery of current from the power source to the second winding for generating torque on the rotor shaft, wherein torque on the rotor shaft causes rotation of the compressor rotor shaft assembly to mitigate thermal bowing during an engine shutdown phase.

2. The gas turbine engine according to claim 1, further comprising a gearbox drivingly coupled with the compressor rotor shaft assembly and the rotor shaft of the PMA.

3. The gas turbine engine according to claim 1, wherein the first plurality of switches is configured to control a direction of the current delivered to the first winding and the second plurality of switches is configured to control a direction of the current delivered to the second winding.

4. The gas turbine engine according to claim 1, further comprising:
a first H-bridge including the first plurality of switches; and
a second H-bridge including the second plurality switches.

5. The gas turbine engine according to claim 1, wherein the power converter circuit is configured to deliver current in at least one of a positive direction or a negative direction to the first and second windings independently to generate the torque on the rotor shaft.

6. The gas turbine engine according to claim 1, wherein the power converter circuit is configured to deliver current to the first winding in a positive direction to rotate the rotor shaft in one of a positive rotational direction or a negative rotational direction to set an initial first rotational position of the rotor shaft.

7. The gas turbine engine according to claim 6, wherein the positive rotational direction is counter-clockwise and the negative rotational direction is clockwise.

8. The gas turbine engine according to claim 6, wherein the power converter circuit is configured to:
deliver current to the second winding in a negative direction to rotate the rotor shaft in the positive rotational direction from the initial first rotational position to a second rotational position;
deliver current to the first winding in a negative direction to rotate the rotor shaft in the positive rotational direction from the second rotational position to a third rotational position;
deliver current to the second winding in a positive direction to rotate the rotor shaft in the positive rotational direction from the third rotational position to a fourth rotational position; and
deliver current to the first winding in a positive direction to rotate the rotor shaft in the positive rotational direction from the fourth rotational position to a fifth rotational position.

9. The gas turbine engine according to claim 8, wherein the power converter circuit is configured to deliver current to the first winding in a positive direction to rotate the rotor shaft in the positive rotational direction from the fifth rotational position to at least one additional rotational position.

10. The gas turbine engine according to claim 8, wherein at each of the rotational positions of the rotor shaft, the power converter circuit is configured to deliver a first pulse of current to one of the first or second windings, rest for a pre-determined time period following the delivery of the first pulse of current, and deliver a second pulse of current to one of the first or second windings following the pre-determined time period to rotate the rotor shaft to a next rotational position.

11. The gas turbine engine according to claim 10, wherein the pre-determined time period is a parameter configured to be controlled for rotating the rotor shaft at a pre-determined rotational speed.

12. A power converter circuit for controlling delivery of current to a permanent magnet alternator (PMA) of a gas turbine engine to mitigate thermal bowing during an engine shutdown phase, the power converter circuit comprising:
a power source;
a first H-bridge connected to a first winding of the PMA and configured to control delivery of current from the power source to the first winding, the first H-bridge including a first plurality of switches configured to control a direction of the current delivered to the first winding, wherein delivery of current to the first winding in one of a positive direction or a negative direction is configured to generate torque on a rotor shaft of the PMA; and
a second H-bridge connected to a second winding of the PMA and configured to control delivery of current from the power source to the second winding, the second H-bridge including a second plurality of switches configured to control a direction of the current delivered to the second winding, wherein delivery of current from the power source to the second winding in one of the positive direction or the negative direction is configured to generate torque on the rotor shaft of the PMA.

13. The power converter circuit according to claim 12, wherein the power source is configured to deliver current to the first winding in the positive direction to rotate the rotor shaft in one of a positive rotational direction or a negative rotational direction to set an initial first rotational position of the rotor shaft.

14. The power converter circuit according to claim 13, wherein the power source is configured to:
deliver current to the second winding in the negative direction to rotate the rotor shaft in the positive rotational direction from the initial first rotational position to a second rotational position;
deliver current to the first winding in the negative direction to rotate the rotor shaft in the positive rotational direction from the second rotational position to a third rotational position;
deliver current to the second winding in the positive direction to rotate the rotor shaft in the positive rotational direction from the third rotational position to a fourth rotational position; and
deliver current to the first winding in the positive direction to rotate the rotor shaft in the positive rotational direction from the fourth rotational position to a fifth rotational position.

15. The power converter circuit according to claim 14, wherein at each of the rotational positions of the rotor shaft, the power converter circuit is configured to deliver a first pulse of current to one of the first or second windings, rest for a pre-determined time period following delivery of the first pulse of current, and deliver a second pulse of current to one of the first or second windings following a predetermined time period to rotate the rotor shaft to a next rotational position.

16. The power converter circuit according to claim 15, wherein the pre-determined time period is a parameter configured to be controlled for rotating the rotor shaft at a pre-determined rotational speed.

17. A method of using a permanent magnet alternator (PMA) to mitigate thermal bowing in a gas turbine engine, the method comprising:
(a) initiating shutdown of a gas turbine engine;
(b) delivering current to a first winding of a PMA in a positive direction to rotate a rotor shaft of the PMA in one of a positive rotational direction or a negative rotational direction to set an initial first rotational position of the rotor shaft;
(c) delivering current to a second winding in the negative direction to rotate the rotor shaft in the positive rotational direction from the initial first rotational position to a second rotational position;
(d) delivering current to the first winding in the negative direction to rotate the rotor shaft in the positive rotational direction from the second rotational position to a third rotational position;
(e) delivering current to the second winding in the positive direction to rotate the rotor shaft in the positive rotational direction from the third rotational position to a fourth rotational position; and
(f) delivering current to the first winding in the positive direction to rotate the rotor shaft in the positive rotational direction from the fourth rotational position to a fifth rotational position.

18. The method according to claim 17, wherein delivery of current to the first and second windings is configured to generate a torque on the rotor shaft to cause rotation of the rotor shaft.

19. The method according to claim 17, further comprising at each of the rotational positions of the rotor shaft:
delivering a first pulse of current to one of the first or second windings;
resting for a pre-determined time period following the delivery of the first pulse of current; and
delivering a second pulse of current to one of the first or second windings following the pre-determined time period to rotate the rotor shaft to a next rotational position.

20. The method according to claim 17, further comprising:
controlling a direction of the current delivered to the first winding using a first H-bridge; and
controlling a direction of the current delivered to the second winding using a second H-bridge.
